(19) United States
(12) Patent Application Publication
(10) Pub. No.: US 2024/0227023 A1
(43) Pub. Date: Jul. 11, 2024

(54) METHOD FOR PRODUCING AN ALUMINUM ALLOY PART IMPLEMENTING AN ADDITIVE MANUFACTURING TECHNIQUE WITH PREHEATING

(71) Applicant: C-TEC Constellium Technology Center, Voreppe (FR)

(72) Inventors: Bechir CHEHAB, Voiron (FR); Ravi SHAHANI, Voreppe (FR)

(21) Appl. No.: 18/562,746

(22) PCT Filed: May 24, 2022
(86) PCT No.: PCT/FR2022/050981

§ 371 Date: Nov. 20, 2023

(30) Foreign Application Priority Data
May 28, 2021 (FR) FR2105626

(51) Int. Cl. B22F 12/13; B22F 10/28; B33Y 10/00; B33Y 40/10; B33Y 40/20; B33Y 70/00

(52) U.S. Cl. CPC B22F 12/13; B22F 10/28; B22F 2301/052; B22F 2999/00; B33Y 10/00; B33Y 40/10; B33Y 40/20; B33Y 70/00

(57) ABSTRACT

A method for manufacturing a part (20) including forming successive metal layers (20₁ . . . 20ₙ), stacked on each other, each layer being formed by depositing an aluminum alloy (15), the aluminum alloy being subjected to an energy input so as to melt down and form said layer when solidifying, the method being characterized in that:
during the manufacture of the part, before the formation of each layer, the aluminum alloy powder is maintained at a temperature higher than or equal to 25° C. and lower than 160° C. or comprised from 300° C. to 500° C.;
the method includes applying, to the part, a post-manufacture heat treatment at a temperature comprised from 300° C. to 400° C.;
the post-manufacture heat treatment begins with an increase in temperature, the increase being performed at a temperature rise rate higher than 5° C. per minute;
the method does not include solution heat treatment followed by quenching.

### TECHNICAL FIELD

The technical field of the invention is a method for manufacturing a part made of an aluminum alloy, implementing an additive manufacturing technique.

### PRIOR ART

Since the 80s, additive manufacturing techniques have been developed, which consist in shaping a part by addition of matter, in contrast with machining techniques, aiming to remove the matter. Formerly restricted to prototyping, additive manufacturing is now operational for manufacturing industrial products in mass production, including metallic parts.

The term “additive manufacturing” is defined according to the French standard XP E67-001: “a set of processes allowing manufacturing, layer after layer, by addition of matter, a physical object based on a digital object”. The standard ASTM F2792-10 defines additive manufacturing too. Different additive manufacturing approaches are also defined and described in the standard ISO/ASTM 17296-1. Resort to an additive manufacture to make an aluminum part, with low porosity, has been described in the document WO2015006447. In general, the application of successive layers is carried out by application of a so-called filler material, and then melting or sintering of the filler material using an energy source such as a laser beam, an electron beam, a plasma torch or an electric arc. Regardless of the additive manufacturing approach that is applied, the thickness of each added layer is in the range of a few tens or hundreds of microns.

Other additive manufacturing methods may be used. Mention may be made for example, and without limitation, of melting or sintering of a filler material in the form of a powder. This may consist of laser melting or sintering. The patent application US20170016096 describes a method for manufacturing a part by localized melting obtained by exposing a powder to an energy beam of the electron beam or laser beam type, the method also being referred to by the acronyms SLM, meaning “Selective Laser Melting”, or LPBF, meaning “Laser Powder Bed Fusion”, or EBM, meaning “Electro Beam Melting”. During the implementation of such a method, to form each layer, a thin layer of powder is placed on a support, for example in the form of a tray. Thus, the powder forms a powder bed. The energy beam sweeps the powder. Sweeping is carried out according to a predetermined digital pattern. Sweeping enables the formation of a layer by meltdown/solidification of the powder. Following the formation of the layer, the latter is covered with a new thickness of powder. The process of forming successive layers, stacked on each other, is repeated until obtaining the final part.

The mechanical properties of the aluminum parts obtained by additive manufacturing depend on the alloy forming the filler metal, and more specifically on its composition as well as on the heat treatments applied following the implementation of the additive manufacture. For example, it has been demonstrated that the addition of elements such as Mn and/or Ni and/or Zr and/or Cu could allow improving the mechanical properties of the part resulting from additive manufacturing.

In general, during the implementation of an LPBF-type process, the powder bed, exposed to the laser beam, is brought to a temperature in the range of 200° C.

The publication by Buchbinder Damien et al “Investigation on reducing distortion by preheating during manufacture of aluminum components using selective lase melting”, Journal of laser applications 26.1 (2014), reports on distortions likely to affect parts manufactured by an LPBF-type process. These distortions are due to residual stresses subsisting in the part. The aforementioned publication indicates that by preheating an aluminum alloy powder to a temperature beyond 150° C., the distortions may be reduced, in comparison with a process implemented without preheating. This publication concludes that the optimum temperature for preheating the powder is at 250° C.

Most devices enabling the implementation of an LPBF-type additive manufacturing process allow preheating the powder up to a temperature in the range of 200° C.

The Inventors have noticed that the preheat temperature has an influence on the cracking resistance properties of parts manufactured by additive manufacturing, based on an aluminum alloy. By selecting the preheat temperature, and by implementing an appropriate post-manufacture heat treatment, the cracking resistance could be significantly improved. This is the object of the invention described hereinafter.

### DISCLOSURE OF THE INVENTION

A first object of the invention is a method for manufacturing a part including forming successive metal layers, stacked on each other, each layer following a pattern defined from a digital model, each layer being formed by exposing a powder of an aluminum alloy to a light beam or to a beam of charged particles, so as to cause meltdown of the powder, followed by solidification, the method being characterized in that:
during the manufacture of the part, before the formation of each layer, the aluminum alloy powder is maintained at a temperature higher than or equal to 25° C. and lower than 160° C. or comprised from 300 to 500° C.;
the method includes applying, to the part, a post-manufacture heat treatment at a temperature comprised from 300° C. to 400° C.;
the post-manufacture heat treatment is performed by exposing the part to a temperature rise higher than 5° C. per minute, so as to reduce the residual stresses in the part and to limit the formation of cracks;
the method does not include solution heat treatment followed by quenching.

Preferably, the powder is maintained at a temperature comprised from 25 to 150° C., and even more preferably from 80° C. to 130° C., according to a first variant.

During the post-manufacture heat treatment, the temperature rise is preferably higher than 10° C. per minute or higher than 20° C. per minute or higher than 40° C. per minute or higher than 100° C. per minute. During the post-manufacture heat treatment, the temperature rise may be instantaneous.

Another object of the invention is a part made of an aluminum alloy formed using a method according to the first object of the invention.

Other advantages and features will appear more clearly from the following description of particular embodiments of the invention, provided as non-limiting examples, and represented in the figures listed hereinbelow.

### FIGURES

FIG. 1 is a diagram illustrating an LPBF-type additive manufacturing method.

FIG. 2 shows an image of a part made of an aluminum alloy manufactured by an LPBF manufacturing process with a crack at an acute angle.

FIG. 3 illustrates the shape of test specimens manufactured by an LPBF manufacturing process.

### DISCLOSURE OF PARTICULAR EMBODIMENTS

Unless stated otherwise, in the description:
the designation of the aluminum alloys is compliant with the nomenclature of The Aluminum Association;
the contents of the chemical elements are reported in % and represent weight fractions. The x % -y % notation means higher than or equal to x % and lower than or equal to y %.

By impurities, it should be understood chemical elements that are unintentionally present in the alloy.

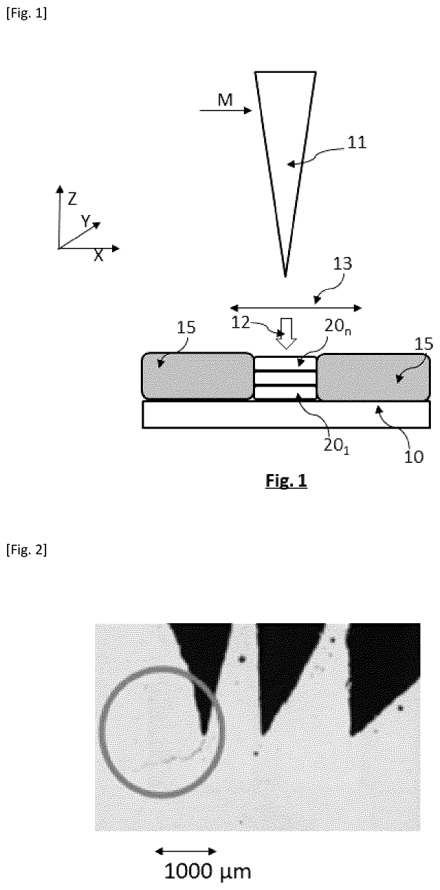

FIG. 1 schematizes the operation of an additive manufacturing process of the laser powder bed fusion (LPBF) type. The filler metal 15 is in the form of an aluminum alloy powder, placed on a support 10. An energy source, in this instance a laser source 11, emits a laser beam 12. The laser source is coupled to the filler material by an optical system 13, the movement of which is determined according to a digital model M. The laser beam 12 propagates according to a propagation axis Z, and follows a movement according to a plane XY, following a pattern dependent on the digital model. For example, the plane is perpendicular to the axis of propagation Z. The interaction of the laser beam 12 with the powder 15 causes a selective melting of the latter, followed by a solidification, resulting in the formation of a layer 20₁ . . . 20ₙ. Once a layer has been formed, it is covered with powder 15 of the filler metal and another layer is formed, superimposed on the layer made before. For example, the thickness of the powder forming one or each layer may be comprised from 10 to 250 μm.

The Inventors have noticed that an increase in the layer thickness could be beneficial to limit the sensitivity to cracking of the alloy during the manufacture of the part and/or during the post-manufacture heat treatment. Preferably, an increase in the layer thickness is accompanied by an adaptation of the laser power, of the vector deviation (distance between two successive laser passes) and/or of the sweep speed of the laser in order to ensure a complete meltdown of each layer of powder in optimum conditions. For example, the thickness of each layer may be comprised from 10 to 250 μm, preferably from 30 to 250 μm, preferably from 50 to 200 μm, preferably from 60 to 180 μm, preferably from 80 to 180 μm, preferably from 90 to 170 μm, preferably from 100 to 160 pm.

The support 10 forms a tray, on which powder layers are successively deposited. The support includes a heating means, allowing preheating the powder prior to exposure to the laser beam 12, at a preheat temperature T determined beforehand. The heating means also allows maintaining the manufactured layers at the temperature T. The heating means may include resistors or induction heating, or by another method for heating the powder bed: heating elements around the powder bed or above the powder bed. The heating elements may consist of heating lamps, or a laser.

The powder may have at least one of the following characteristics:
Average particle size from 5 to 100 μm, preferably from 5 to 25 μm, or from 20 to 60 μm. The given values mean that at least 80% of the particles have an average size within the specified range;
Spherical shape. The sphericity of a powder may for example be determined using a morphogranulometer;
Good castability. For example, the castability of a powder may be determined according to the standard ASTM B213 or the standard ISO 4490:2018. According to the standard ISO 4490:2018, the flow time is preferably lower than 50 seconds;
Low porosity, preferably from 0 to 5%, more preferably from 0 to 2%, even more preferably from 0 to 1% by volume. In particular, the porosity may be determined by scanning electron microscopy or by helium pycnometry (cf. the standard ASTM B923);
Absence or small amount (less than 10%, preferably less than 5% by volume) of small particles (1 to 20% of the average size of the powder), called satellites, which stick to the larger particles.

For example, the powder may be obtained by gas jet atomization, plasma atomization, water jet atomization, ultrasound atomization, centrifugation atomization, electrolysis and spheroidization, or grinding and spheroidization.

Preferably, the powder according to the present invention is obtained by atomization by gas jet. The process of atomization by gas jet starts with casting of a molten metal through a nozzle. Afterwards, the molten metal is hit by jets of neutral gases, such as nitrogen or argon, possibly accompanied by other gases, and atomized into very small droplets which cool down and solidify when falling inside an atomization tower. Afterwards, the powders are collected in a can. The process of atomization by gas jet has the advantage of producing a powder having a spherical shape, in contrast with the atomization by water jet which produces a powder having an irregular shape. Another advantage of atomization by gas jet is a good powder density, in particular thanks to the spherical shape and to the particle size distribution. Still another advantage of this process is good repeatability of the particle size distribution.

After manufacture thereof, the powder according to the present invention may be oven-dried, in particular in order to reduce the humidity thereof. The powder may also be packaged and stored between the manufacture and the use thereof.

The Inventors have implemented an additive manufacturing process to make aluminum alloy parts. However, the Inventors observed that when the powder was preheated, to a temperature comprised from 160° C. to 290° C., the produced parts could present a risk of cracking, in particular at acute angles. For example, FIG. 2 shows the apparition of a crack on a part formed from an aluminum alloy including Zr according to a mass fraction in the range of 1%. The crack is surrounded by a circle in the figure. The aluminum part has been manufactured by LPBF, the powder having been preheated to 200° C., the manufacture having been followed by a post-manufacture heat treatment at a temperature of 300° C. for two hours. The crack has appeared following the post-manufacture heat treatment.

The Inventors estimate that the crack is probably related to the preheat temperature of the powder, which is not optimum. Depending on the usual additive manufacturing processes, the temperature of the powder bed is generally comprised from 150° C. to 200° C. The layers formed by the additive manufacturing process may be subjected to such a temperature range for a long period of time, possibly exceeding several hours. These conditions are deemed to promote cracking. Thus, the Inventors consider that it is necessary to avoid preheating the powder to temperatures comprised from 160° C. to 290° C.

The Inventors have noticed that when the temperature of the preheated powder bed is lower than 160° C. and preferably higher than 30° C., the parts have a better resistance to cracking. Preferably, preheating of the powder bed may be performed at a temperature lower than or equal to 140° C., or, better still, lower than or equal to 130° C. The preheat temperature is higher than the room temperature. The preferred preheat temperature ranges T of the powder bed are: 25° C.≤T≤150° C., preferably 50° C.≤T≤150° C., preferably 50° C.≤T≤140° C., preferably 60° C.≤T≤140° C., preferably 70° C.≤T≤135° C., preferably 80° C.≤T≤130° C.

Carrying out a post-manufacture heat treatment, the manufacture being carried out by an additive manufacturing process, allows creating stress relief conditions allowing suppressing the residual stresses as well as a precipitation of hardening phases. This is also referred to as thermal stress relief. The Inventors have observed that it was preferable for the setpoint temperature T′ of the post-manufacture heat treatment to be comprised from 300° C. to 500° C., the duration of the post-manufacture heat treatment being adapted to the implemented temperature and the volume of the part: in general, the duration of the post-manufacture heat treatment is comprised from 10 minutes to 50 hours. A post-manufacture heat treatment temperature T′ comprised from 300° C. to 400° C. is preferred. At these temperatures, the duration of the post-manufacture heat treatment is preferably comprised from 30 minutes to 10 hours.

Besides the temperature of the post-manufacture heat treatment, the temperature rise, initiating the post-manufacture heat treatment, is preferably as rapid as possible. For example, during the temperature rise, the temperature rise rate ΔT′ (usually referred to by a person skilled in the art as “heating rate” in ° C. per minute or in ° C. per second) is preferably higher than 5° C. per minute or higher than 10° C. per minute, and more preferably higher than 20° C. per minute and more preferably higher than 40° C. per minute, and more advantageously higher than 100° C. per minute. By temperature rise, it should be understood the rise in temperature to which the part is subjected during the post-manufacture heat treatment. It seems optimum for the temperature rise to be instantaneous, i.e. for the manufactured part to be subjected, as of the beginning of the post-manufacture heat treatment, to the setpoint temperature T′ of the post-manufacture heat treatment. An instantaneous temperature rise may be obtained by placing the manufactured part in a hot furnace, already set at the setpoint temperature T′, or by rapid heating means of the fluidized bed or molten salt bath type. The temperature rise may also be ensured by induction heating.

For the same temperature rise outside the part, the temperature variation inside the part depends in particular on the heating medium (liquid or air or inert gas) as well as the shape of the part. In particular, the temperature across the thickness or at the surface of the part may be different. This is the reason why the aforementioned temperature rise corresponds to the temperature outside the part. The combination of a preheat temperature T, a post-manufacture heat treatment temperature T′ and a temperature rise rate ΔT′, during the temperature rise of the post-manufacture heat treatment, in the aforementioned value ranges, allows obtaining parts having good resistance to cracking.

According to one alternative, the preheat temperature corresponds to the conditions under which an effective stress relief could be obtained. The temperature range T may then be comprised from 300° C. to 500° C. It is considered that at this temperature range, the manufacturing conditions of the part generate less residual stresses. According to this alternative, a stress relief post-manufacture heat treatment as previously described is also relevant.

According to one possibility, the post-manufacture heat treatment may be replaced or supplemented by hot isostatic pressing, at a temperature comprised from 300° C. to 500° C. In particular, the CIC treatment may allow further improving the elongation properties and the fatigue properties. Hot isostatic pressing may be carried out before, after, or instead of the post-manufacture heat treatment. The CIC treatment may be performed at a pressure from 500 to 3,000 bars and for a duration from 0.5 to 10 hours.

According to a first variant, the metal forming the powder 15 is an aluminum alloy comprising at least the following alloy elements:
at least one element selected from among Zr, Sc, Hf, Ti, V, Er, Tm, Yb and/or Lu, according to a mass fraction higher than or equal to 0.30%, preferably 0.30-2.50%, preferably 0.40-2.00%, more preferably 0.40-1.80%, even more preferably 0.50-1.60%, even more preferably 0.60-1.50%, even more preferably 0.70-1.40%, even more preferably 0.80-1.20% in total;
   These elements may allow increasing the mechanical strength of the alloy by solid solution hardening and/or by formation of dispersoids which could appear during the manufacture of the part and/or during post-manufacture heat treatments. The elements, Zr, Sc, HF and Ti may further allow controlling the granular structure during laser melting by promoting the apparition of equiaxed grains.
optionally Mg, according to a mass fraction lower than 0.30%, preferably lower than 0.10%, more preferably lower than 0.05%;
   This element may allow increasing the mechanical strength of the alloy by solid solution hardening.
   However, it could be sensitive to evaporation during laser melting, which could lead to the formation of fumes and instabilities of the melted areas. For these reasons, the addition of this element should be limited and preferably avoided.
optionally Zn, according to a mass fraction lower than 0.30%, preferably lower than 0.10%, more preferably lower than 0.05%;
   This element may allow increasing the mechanical strength of the alloy by solid solution hardening. However, it could be sensitive to evaporation during laser melting, which could lead to the formation of fumes and instabilities of the melted areas. For these reasons, the addition of this element should be limited and preferably avoided.
optionally at least one element selected from among: Ni, Mn, Cr and/or Cu, according to a mass fraction from 0.50 to 7.00%, preferably from 1.00 to 6.00% each; preferably, according to a mass fraction lower than 25.00%, preferably lower than 20.00%, more preferably lower than 15.00% in total;
   These elements may allow increasing the mechanical strength of the alloy by solid solution hardening and/or by formation of dispersoids which could appear during the manufacture of the part and/or during post-manufacture heat treatments.
optionally at least one element selected from among: W, Nb, Ta, Y, Nd, Ce, Co, Mo and/or mischmetal, according to a mass fraction lower than or equal to 5.00%, preferably lower than or equal to 3% each, and lower than or equal to 15.00%, preferably lower than or equal to 12%, more preferably lower than or equal to 5% in total;
   These elements may allow increasing the mechanical strength of the alloy by solid solution hardening and/or by formation of dispersoids which could appear during the manufacture of the part and/or during post-manufacture heat treatments.
optionally at least one element selected from among: Si, La, Sr, Ba, Sb, Bi, Ca, P, B, In and/or Sn, according to a mass fraction lower than or equal to 1.00%, preferably lower than or equal to 0.5%, preferably lower than or equal to 0.3%, more preferably lower than or equal to 0.1%, even more preferably lower than or equal to 700 ppm each, and lower than or equal to 2.00%, preferably lower than or equal to 1% in total;
   These elements may allow increasing the mechanical strength of the alloy by solid solution hardening and/or by formation of dispersoids which could appear during the manufacture of the part and/or during post-manufacture heat treatments.
optionally Fe, according to a mass fraction from 0.50 to 7.00%, preferably from 1.00 to 6.00% according to a first variant, or according to a mass fraction lower than or equal to 1.00%, preferably lower than or equal to 0.5%, preferably lower than or equal to 0.3%, more preferably lower than or equal to 0.1%, even more preferably lower than or equal to 700 ppm according to a second variant; This element may allow increasing the mechanical strength of the alloy by solid solution hardening and/or by formation of dispersoids which could form during the manufacture of the part and/or during post-manufacture heat treatments.
optionally at least one element selected from among: Ag according to a mass fraction from 0.06 to 1.00% and/or Li according to a mass fraction from 0.06 to 1.00%;
   The Li may allow increasing the mechanical strength of the alloy by solid solution hardening. However, it could be sensitive to evaporation during laser melting, which could lead to the formation of fumes and instabilities of the melted areas. For these reasons, the addition of this element should be limited, preferably avoided.
   The Ag may allow increasing the mechanical strength of the alloy by solid solution hardening and facilitating the germination of other hardening precipitates, such as Al2Cu-type precipitates for example.
optionally impurities according to a mass fraction lower than 0.05% each (namely 500 ppm) and lower than 0.15% in total;
the rest being aluminum.
   According to a second variant, the metal 15 forming the powder is an aluminum alloy comprising at least the following alloy elements:
Zr and at least one element selected from among: Ti, V, Sc, Hf, Er, Tm, Yb and Lu, according to a mass fraction higher than or equal to 0.30%, preferably 0.30-2.5%, preferably 0.40-2.0%, more preferably 0.40-1.80%, even more preferably 0.50-1.60%, even more preferably 0.60-1.50%, even more preferably 0.70-1.40%, even more preferably 0.80-1.20% in total, knowing that Zr represents from 10 to less than 100% of the percentage ranges given hereinbefore;
optionally Mg, according to a mass fraction lower than 0.30%, preferably lower than 0.10%, more preferably lower than 0.05%;
optionally Zn, according to a mass fraction lower than 0.30%, preferably lower than 0.10%, more preferably lower than 0.05%;
optionally at least one element selected from among: Ni, Mn, Cr and/or Cu, according to a mass fraction from 0.50 to 7.00%, preferably from 1.00 to 6.00% each; preferably, according to a mass fraction lower than 25.00%, preferably lower than 20.00%, more preferably lower than 15.00% in total;
optionally at least one element selected from among: W, Nb, Ta, Y, Nd, Ce, Co, Mo and/or mischmetal, according to a mass fraction lower than or equal to 5.00%, preferably lower than or equal to 3% each, and lower than or equal to 15.00%, preferably lower than or equal to 12%, more preferably lower than or equal to 5% in total;
optionally at least one element selected from among: Si, La, Sr, Ba, Sb, Bi, Ca, P, B, In and/or Sn, according to a mass fraction lower than or equal to 1.00%, preferably lower than or equal to 0.5%, preferably lower than or equal to 0.3%, more preferably lower than or equal to 0.1%, even more preferably lower than or equal to 700 ppm each, and lower than or equal to 2.00%, preferably lower than or equal to 1% in total;
optionally Fe, according to a mass fraction from 0.50 to 7.00%, preferably from 1.00 to 6.00% according to a first variant, or according to a mass fraction lower than or equal to 1.00%, preferably lower than or equal to 0.5%, preferably lower than or equal to 0.3%, more preferably lower than or equal to 0.1%, even more preferably lower than or equal to 700 ppm according to a second variant;
optionally at least one element selected from among: Ag according to a mass fraction from 0.06 to 1.00% and/or Li according to a mass fraction from 0.06 to 1.00%;
optionally impurities according to a mass fraction lower than 0.05% each (namely 500 ppm) and lower than 0.15% in total;
the rest being aluminum.
   According to a third variant, the metal forming the powder 15 is an aluminum alloy comprising at least the following alloy elements:
Zr, according to a mass fraction higher than or equal to 0.30%, preferably 0.30-2.50%, preferably 0.40-2.00%, more preferably 0.40-1.80%, even more preferably 0.50-1.60%, even more preferably 0.60-1.50%, even more preferably 0.70-1.40%, even more preferably 0.80-1.20%;
Sc, according to a mass fraction lower than 0.30%, preferably lower than 0.20%, preferably lower than 0.10%, more preferably lower than 0.05%;
optionally Mg, according to a mass fraction lower than 0.30%, preferably lower than 0.10%, more preferably lower than 0.05%;
optionally Zn, according to a mass fraction lower than 0.30%, preferably lower than 0.10%, more preferably lower than 0.05%;
optionally at least one element selected from among: Ni, Mn, Cr and/or Cu, according to a mass fraction from 0.50 to 7.00%, preferably from 1.00 to 6.00% each; preferably, according to a mass fraction lower than 25.00%, preferably lower than 20.00%, more preferably lower than 15.00% in total;
optionally at least one element selected from among: Hf, Ti, Er, W, Nb, Ta, Y, Yb, Nd, Ce, Co, Mo, Lu, Tm, V and/or mischmetal, according to a mass fraction lower than or equal to 5.00%, preferably lower than or equal to 3% each, and lower than or equal to 15.00%, preferably lower than or equal to 12%, more preferably lower than or equal to 5% in total;
optionally at least one element selected from among: Si, La, Sr, Ba, Sb, Bi, Ca, P, B, In and/or Sn, according to a mass fraction lower than or equal to 1.00%, preferably lower than or equal to 0.5%, preferably lower than or equal to 0.3%, more preferably lower than or equal to 0.1%, even more preferably lower than or equal to 700 ppm each, and lower than or equal to 2.00%, preferably lower than or equal to 1% in total;
optionally Fe, according to a mass fraction from 0.50 to 7.00%, preferably from 1.00 to 6.00% according to a first variant, or according to a mass fraction lower than or equal to 1.00%, preferably lower than or equal to 0.5%, preferably lower than or equal to 0.3%, more preferably lower than or equal to 0.1%, even more preferably lower than or equal to 700 ppm according to a second variant;
optionally at least one element selected from among: Ag according to a mass fraction from 0.06 to 1.00% and/or Li according to a mass fraction from 0.06 to 1.00%;
optionally impurities according to a mass fraction lower than 0.05% each (namely 500 ppm) and lower than 0.15% in total;
the rest being aluminum.

Preferably, the alloy according to the present invention comprises a weight fraction of at least 80%, more preferably of at least 85%, of aluminum.

Melting of the powder may be partial or total. Preferably, from 50 to 100% of the exposed powder melts, more preferably from 80 to 100%.

Preferably, according to a particular example of the invention, the aluminum alloy comprises:
Zr, according to a mass fraction from 0.50 to 3.00%, preferably from 0.50 to 2.50%, preferably from 0.60 to 1.40%, more preferably from 0.70 to 1.30%, even more preferably from 0.80 to 1.20%, even more preferably from 0.85 to 1.15%; even more preferably from 0.90 to 1.10%;
Mn, according to a mass fraction from 1.00 to 7.00%, preferably from 1.00 to 6.00%, preferably from 2.00 to 5.00%; more preferably from 3.00 to 5.00%, even more preferably from 3.50 to 4.50%;
Ni, according to a mass fraction from 1.00 to 6.00%, preferably from 1.00 to 5.00%, preferably from 2.00 to 4.00%, more preferably from 2.50 to 3.50%;
optionally Fe, according to a mass fraction lower than or equal to 1.00%, preferably lower than or equal to 0.50%, preferably lower than or equal to 0.30%; and preferably higher than or equal to 0.05, preferably higher than or equal to 0.10%;
optionally Si, according to a mass fraction lower than or equal to 1.00%, preferably lower than or equal to 0.50%;
optionally Cu, according to a mass fraction from 1.00 to 5.00%, preferably from 1.00 to 3.00%, preferably from 1.50 to 2.50%.

The elements Hf, Ti, Er, W, Nb, Ta, Y, Yb, Nd, Ce, Co, Mo, Lu, Tm, V and/or mischmetal could lead to the formation of dispersoids or fine intermetallic phases allowing increasing the hardness of the obtained material. As known to a person skilled in the art, the mischmetal composition is generally about 45 to 50% cerium, 25% lanthanum, 15 to 20% neodymium and 5% praseodymium.

According to one embodiment, the addition of La, Bi, Mg, Er, Yb, Y, Sc and/or Zn is avoided, the preferred mass fraction of each of these elements then being lower than 0.05%, and preferably lower than 0.01%.

According to another embodiment, the addition of Fe and/or Si is avoided. However, it is known to a person skilled in the art that these two elements are generally present in common aluminum alloys with the contents as defined hereinbefore. Hence, the contents as described hereinbefore may also correspond to impurity contents for Fe and Si.

The elements Ag and Li may act on the strength of the material by hardening precipitation or by their effect on the properties of the solid solution.

Optionally, the alloy may also comprise at least one element for refining the grains, for example AlTIC or AlTiB2 (for example in the AT5B or AT3B form), according to an amount less than or equal to 50 kg/ton, preferably less than or equal to 20 kg/ton, even more preferably less than or equal to 12 kg/ton each, and less than or equal to 50 kg/ton, preferably less than or equal to 20 kg/ton in total.

There are several means for heating the part manufacturing enclosure (and therefore the powder bed) in additive manufacturing. For example, mention may be made of the use of a heating construction tray, or heating by a laser, by induction, by heating lamps or by heating resistors which may be placed under and/or inside the construction tray, and/or around the powder bed. In the case where a laser is used to heat the powder bed, this laser is preferably de-focused, and may be either co-axial with the main laser which is used to melt down the powder, or separated from the main laser.

According to one embodiment, the method may be a construction method with a high deposition rate. For example, the deposition rate may be higher than 4 mm³/s, preferably higher than 6 mm³/s, more preferably higher than 7 mm³/s. The deposition rate is calculated as the product between the sweep speed (in mm/s), the vector deviation (in mm) and the layer thickness (in mm).

According to one embodiment, the method may use a laser, and optionally several lasers.

According to another embodiment, suited to alloys with structural hardening, it is possible to carry out a solution heat treatment followed by quenching and tempering of the formed part and/or a hot isostatic pressing. In this case, the hot isostatic pressing may advantageously replace the dissolution. However, the method according to the invention is advantageous because it preferably does not require any solution heat treatment followed by quenching. The solution heat treatment may have a detrimental effect on the mechanical strength in some cases by participating in an enlargement of dispersoids or fine intermetallic phases. Moreover, on parts with a complex shape, the quenching operation could lead to a distortion of the parts, which would limit the primary advantage of use of additive manufacturing, which is obtaining parts directly in their final or almost-final shape.

According to one embodiment, the method according to the present invention further includes, optionally, a machining treatment, and/or a chemical, electrochemical or mechanical surface treatment, and/or a vibratory finishing. In particular, these treatments may be carried out to reduce the roughness and/or improve the corrosion resistance and/or improve the resistance to fatigue cracking.

Optionally, it is possible to carry out a mechanical deformation of the part, for example after the additive manufacturing and/or before the post-manufacture heat treatment.

Optionally, it is possible to carry out an assembly operation with one or more other part(s), by known assembly methods. As exemplary assembly methods, mention may be made of:
bolting, riveting or other mechanical assembly methods;
fusion welding;
friction welding;
brazing.

### EXPERIMENTAL TESTS

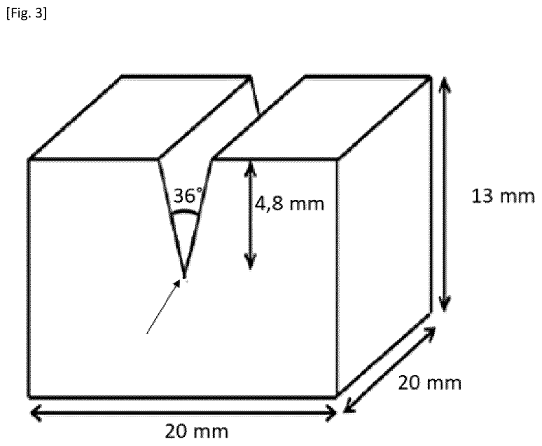

Several test specimens have been formed, according to the geometry shown in FIG. 3. These test specimens have an acute angle, marked with an arrow, forming a site conducive to the formation of cracks.

The used alloy was an aluminum alloy including: Mn: 4%-Ni: 2.85%-Cu: 1.93%-Zr: 0.88%. The composition has been determined by ICP-MS (Induced Coupled Plasma Mass Spectrometry). A powder has been obtained by gas jet atomization (Argon). The size of the particles was essentially comprised from 3 μm to 100 μm, with a D10 (10% fractile) of 27 μm, a D50 (median diameter) of 43 μm and a D90 (90% fractile) of 62 μm.

Starting from the powder, the test specimens have been formed using LPBF EOSM290 equipment (supplier EOS). During the manufacture of the test specimens, the operating parameters were: laser power: 370 W—sweep speed: 1,400 mm/s—vector deviation 0.11 mm—thickness of each layer: 60 μm—heating temperature of the tray (preheat temperature): 100° C.

During manufacture, the test specimens have been arranged on a tray with a 250 mm×250 mm size, and a 20 mm thickness. After manufacture, the test specimens have been kept secured to the tray, the latter having been cut into portions with a 30 mm×30 mm section, with a 20 mm thickness, each portion of the tray being connected to a test specimen. Part of the test specimens, secured to a portion of the tray, has undergone a stress relief through a post-manufacture heat treatment.

Maintaining the test specimens secured to the tray (or more specifically to a tray portion) is a common practice to a person skilled in the art, which, without being bound by theory, allows not relieving the residual stresses induced by the LPBF manufacturing process before the post-manufacture heat treatment. If the test specimens had been separated from the tray before the post-manufacture heat treatment, then a distortion of the test specimens might happen, in particular in the case of a complex geometry.

During the post-manufacture heat treatment, the test specimens have been:
either arranged in a hot furnace, already set at the stress relief temperature: the temperature rise is then considered to be instantaneous.
or brought to the stress relief temperature according to a temperature rise rate of 1.6° C. per minute.

After the stress relief, the test specimens have been separated from their respective tray portion and mechanically polished on the face on which the observation of the cracking will be carried out, as illustrated in FIG. 3 (an arrow shows the considered face). The total length of a possible crack formed starting from the acute angle has been measured. The length of the crack has been measured using an optical microscope with a ×50 magnification.

Table 1 reports the results obtained on eight test specimens.

TABLE 1

| | Stress relief | | | |
|---|---|---|---|---|
| | temperature | Temperature | Stress relief | Cracking |
| Test | (° C.) | rise | duration (h) | length (μm) |
| 1 | 160 | instantaneous | 15 | 1045 |
| 2 | 180 | instantaneous | 8 | 636 |
| 3 | 220 | instantaneous | 8 | 1636 |
| 4 | 260 | instantaneous | 8 | 1273 |
| 5 | 300 | instantaneous | 4 | 0 |
| 6 | 320 | instantaneous | 4 | 0 |
| 7 | 340 | instantaneous | 4 | 0 |
| 8 | 300 | 1.6° C./minute | 4 | 1545 |

The tests show that an instantaneous rise in temperature, obtained by loading the test specimen in the furnace, already set at the post-manufacture heat treatment temperature, is optimum (absence of cracking) when the temperature of the post-manufacture heat treatment is higher than 300° C. The comparison of the tests 8 (progressive rise in temperature up to 300° C. and 5 (instantaneous rise to the temperature of 300° C.) shows that it is preferable for the temperature rise to be rapid, and even instantaneous. Thus, to avoid the apparition of a crack during the stress relief, it is preferable for the temperature rise to be as rapid as possible.

Moreover, other additive manufacturing processes, based on powders, may be considered, without departing from the scope of the invention, for example, and without limitation:
Selective Laser Sintering (or SLS);
Direct Metal Laser Sintering (or DMLS);
Selective Heat Sintering (or SHS);
Electron Beam Melting (or EBM);
Laser Melting Deposition;
Direct Energy Deposition (or DED);
Direct Metal Deposition (or DMD);
Direct Laser Deposition (or DLD);
Laser Deposition Technology;
Laser Engineering Net Shaping;
Laser Cladding Technology;
Laser Freeform Manufacturing Technology (or LFMT);
Laser Metal Deposition (or LMD);
Cold Spray Consolidation (or CSC);
Additive Friction Stir (or AFS);
Field Assisted Sintering Technology, FAST or spark plasma sintering; or
Inertia Rotary Friction Welding (or IRFW).

1. A method for manufacturing a part comprising forming successive metal layers stacked on each other, each layer following a pattern defined from a digital model, each layer being formed by exposing a powder of an aluminum alloy to a light beam or to a beam of charged particles, so as to cause meltdown of the powder, followed by solidification, the method comprising:
during manufacture of the part, before formation of each layer, the aluminum alloy powder is maintained at a temperature higher than or equal to 25° C. and lower than 160° C. or comprised from 300 to 500° C.;
the method further comprises applying to the part, a post-manufacture heat treatment at a temperature (T′) comprised from 300° C. to 400° C.;
the post-manufacture heat treatment is performed by exposing the part to a temperature rise (ΔT′) higher than 5° C. per minute;
the method does not include solution heat treatment followed by quenching.

2. The method according to claim 1, wherein the powder is maintained at a temperature comprised-from 25 to 150° C.

3. The method according to claim 2, wherein the powder is maintained at a temperature comprised-from 80° C. to 130° C.

4. The method according to claim 1, wherein during the post-manufacture heat treatment, the temperature rise (ΔT′) is higher than 10° C. per minute or higher than 20° C. per minute or higher than 40° C. per minute.

5. The method according to claim 1, wherein during the post-manufacture heat treatment, the temperature rise (ΔT′) is instantaneous.

6. The method according to claim 1, wherein the aluminum alloy includes at least the following alloy elements:
at least one element selected from among Zr, Sc, Hf, Ti, V, Er, Tm, Yb and/or Lu, according to a mass fraction higher than or equal to 0.30%, optionally 0.30-2.50%. optionally 0.40-2.00%, optionally 0.40-1.80%, optionally 0.50-1.60%, optionally 0.60-1.50%, optionally 0.70-1.40%, optionally 0.80-1.20% in total;
optionally Mg, according to a mass fraction lower than 0.30%, optionally lower than 0.10%, optionally lower than 0.05%;
optionally Zn, according to a mass fraction lower than 0.30%, optionally lower than 0.10%, optionally lower than 0.05%;
optionally at least one element selected from among: Ni, Mn, Cr and/or Cu, according to a mass fraction from 0.50 to 7.00%, optionally from 1.00 to 6.00% each;
optionally, according to a mass fraction lower than 25.00%, optionally lower than 20.00%, optionally lower than 15.00% in total;
optionally at least one element selected from among: W, Nb, Ta, Y, Nd, Ce, Co, Mo and/or mischmetal, according to a mass fraction lower than or equal to 5.00%, optionally lower than or equal to 3% each, and lower than or equal to 15.00%, optionally lower than or equal to 12%, optionally lower than or equal to 5% in total;
optionally at least one element selected from among: Si, La, Sr, Ba, Sb, Bi, Ca, P, B, In and/or Sn, according to a mass fraction lower than or equal to 1.00%, optionally lower than or equal to 0.5%, optionally lower than or equal to 0.3%, optionally lower than or equal to 0.1%, optionally lower than or equal to 700 ppm each, and lower than or equal to 2.00%, optionally lower than or equal to 1% in total;
optionally Fe, according to a mass fraction from 0.50 to 7.00%, optionally from 1.00 to 6.00% according to a first variant, or according to a mass fraction lower than or equal to 1.00%, optionally lower than or equal to 0.5%, optionally lower than or equal to 0.3%, optionally lower than or equal to 0.1%, optionally lower than or equal to 700 ppm according to a second variant;
optionally at least one element selected from among: Ag according to a mass fraction from 0.06 to 1.00% and/or Li according to a mass fraction from 0.06 to 1.00%;
optionally impurities according to a mass fraction lower than 0.05% each, 500 ppm, and lower than 0.15% in total;
remainder aluminum.

7. The method according to claim 1, wherein the aluminum alloy includes at least the following alloy elements:
Zr and at least one element selected from among: Ti, V, Sc, Hf, Er, Tm, Yb and Lu, according to a mass fraction higher than or equal to 0.30%, optionally 0.30-2.5%, optionally 0.40-2.0%, optionally 0.40-1.80%, optionally 0.50-1.60%, optionally 0.60-1.50%, optionally 0.70-1.40%, optionally 0.80-1.20% in total, knowing that Zr represents from 10 to less than 100% of the percentage ranges given hereinbefore;
optionally Mg, according to a mass fraction lower than 0.30%, optionally lower than 0.10%, optionally lower than 0.05%;
optionally Zn, according to a mass fraction lower than 0.30%, optionally lower than 0.10%, optionally lower than 0.05%;
optionally at least one element selected from among: Ni, Mn, Cr and/or Cu, according to a mass fraction from 0.50 to 7.00%, optionally from 1.00 to 6.00% each;
optionally, according to a mass fraction lower than 25.00%, optionally lower than 20.00%, optionally lower than 15.00% in total;
optionally at least one element selected from among: W, Nb, Ta, Y, Nd, Ce, Co, Mo and/or mischmetal, according to a mass fraction lower than or equal to 5.00%, optionally lower than or equal to 3% each, and lower than or equal to 15.00%, optionally lower than or equal to 12%, optionally lower than or equal to 5% in total;
optionally at least one element selected from among: Si, La, Sr, Ba, Sb, Bi, Ca, P, B, In and/or Sn, according to a mass fraction lower than or equal to 1.00%, optionally lower than or equal to 0.5%, optionally lower than or equal to 0.3%, optionally lower than or equal to 0.1%, optionally lower than or equal to 700 ppm each, and lower than or equal to 2.00%, optionally lower than or equal to 1% in total;
optionally Fe, according to a mass fraction from 0.50 to 7.00%, optionally from 1.00 to 6.00% according to a first variant, or according to a mass fraction lower than or equal to 1.00%, optionally lower than or equal to 0.5%, optionally lower than or equal to 0.3%, optionally lower than or equal to 0.1%, optionally lower than or equal to 700 ppm according to a second variant;
optionally at least one element selected from among: Ag according to a mass fraction from 0.06 to 1.00% and/or Li according to a mass fraction from 0.06 to 1.00%;
optionally impurities according to a mass fraction lower than 0.05% each, (500 ppm and lower than 0.15% in total;
the rest being aluminum.

8. The method according to claim 1, wherein the aluminum alloy includes at least the following alloy elements:
Zr, according to a mass fraction higher than or equal to 0.30%, optionally 0.30-2.50%, optionally 0.40-2.00%, optionally 0.40-1.80%, optionally 0.50-1.60%, optionally 0.60-1.50%, optionally 0.70-1.40%, optionally 0.80-1.20%;
Sc, according to a mass fraction lower than 0.30%, optionally lower than 0.20%, optionally lower than 0.10%, optionally lower than 0.05%;
optionally Mg, according to a mass fraction lower than 0.30%, optionally lower than 0.10%, optionally lower than 0.05%;
optionally Zn, according to a mass fraction lower than 0.30%, optionally lower than 0.10%, optionally lower than 0.05%;
optionally at least one element selected from among: Ni, Mn, Cr and/or Cu, according to a mass fraction from 0.50 to 7.00%, optionally from 1.00 to 6.00% each;
optionally, according to a mass fraction lower than 25.00%, optionally lower than 20.00%, optionally lower than 15.00% in total;
optionally at least one element selected from among: Hf, Ti, Er, W, Nb, Ta, Y, Yb, Nd, Ce, Co, Mo, Lu, Tm, V and/or mischmetal, according to a mass fraction lower than or equal to 5.00%, optionally lower than or equal to 3% each, and lower than or equal to 15.00%, optionally lower than or equal to 12%, optionally lower than or equal to 5% in total;
optionally at least one element selected from among: Si, La, Sr, Ba, Sb, Bi, Ca, P, B, In and/or Sn, according to a mass fraction lower than or equal to 1.00%, optionally lower than or equal to 0.5%, optionally lower than or equal to 0.3%, optionally lower than or equal to 0.1%, optionally lower than or equal to 700 ppm each, and lower than or equal to 2.00%, optionally lower than or equal to 1% in total;
optionally Fe, according to a mass fraction from 0.50 to 7.00%, optionally from 1.00 to 6.00% according to a first variant, or according to a mass fraction lower than or equal to 1.00%, optionally lower than or equal to 0.5%, optionally lower than or equal to 0.3%, optionally lower than or equal to 0.1%, optionally lower than or equal to 700 ppm according to a second variant;
optionally at least one element selected from among: Ag according to a mass fraction from 0.06 to 1.00% and/or Li according to a mass fraction from 0.06 to 1.00%;
optionally impurities according to a mass fraction lower than 0.05% each (namely 500 ppm) and lower than 0.15% in total;
remainder aluminum.

9. The method according to claim 1, wherein the aluminum alloy includes at least 80% and optionally at least 85% aluminum.

10. The method according to claim 1, wherein the thickness of each layer is comprised from 10 to 250 μm, optionally from 30 to 250 μm, optionally from 50 to 200 μm, optionally from 60 to 180 μm, optionally from 80 to 180 μm, optionally from 90 to 170 μm, optionally from 100 to 160 μm.

11. An aluminum alloy part formed from a method according to claim 1.
